(19) United States
(12) Patent Application Publication
(10) Pub. No.: US 2022/0033931 A1
(43) Pub. Date: Feb. 3, 2022

(54) COOLING METHOD AND DEVICE FOR COOLING A WIRE AND CORRESPONDING WIRE-PROCESSING INSTALLATION

(71) Applicant: DRUIDS PROCESS TECHNOLOGY, S.L., Granollers (ES)

(72) Inventors: Raimon PÉREZ SOLDEVILA, Premià de Dalt (ES); F. Javier AYESA MORROS, Cabrils (ES); Carlos BITTNER, El Masnou (ES)

(21) Appl. No.: 17/292,553

(22) PCT Filed: Nov. 14, 2018
(86) PCT No.: PCT/ES2018/070736

§ 371 Date: Sep. 29, 2021

(51) Int. Cl. C21D 9/573; C21D 9/56; C21D 1/60; C21D 1/667; C21D 1/74; F27D 9/00

(52) U.S. Cl. CPC C21D 9/5732; C21D 9/561; C21D 1/60; C21D 1/667; F27D 2009/0081; F27D 9/00; C21D 2241/00; F27D 2009/007; C21D 1/74

(57) ABSTRACT

Cooling device (1) for cooling a wire (100), comprising a first chamber (2) and a second cooling chamber (4) through which the wire (100) passes. The device also comprises cooling liquid driving means (16) for driving the cooling liquid from the first chamber (2) to the second chamber (4) through at least one coding liquid inlet (12). Through the driving means (16) and the cooling liquid inlet (12), a jet of coding liquid is projected on the wire path at a mean speed of at least 0.6 m/s, and at a distance between 6 and 13 times the diameter of the wire (100). Cooling is performed in an inert gas atmosphere inside the second chamber (4). The invention also relates to a corresponding installation and a corresponding wire cooling method.

### FIELD OF THE INVENTION

The invention relates to a cooling device for cooling a wire comprising a first containing chamber for containing a cooling liquid.

The invention also relates to a wire processing installation incorporating the cooling device for cooling the wire according to the invention.

Likewise, the invention relates to a cooling method for cooling a wire.

### STATE OF THE ART

One of the steps for manufacturing a wire, and particularly a steel wire, is the annealing step or patenting step.

In the annealing step, the wire is heated between 650 and 750° C. The purpose of annealing is to soften the wire for eliminating internal stresses and for making subsequent handling easier.

In the patenting step, the wire is heated between 825 and 950° C. The purpose of this treatment is to transform the crystalline structure of austenite into perlite, which provides the steel with ductility.

In an annealing process, and particularly in a patenting process, the wire must be cooled at a controlled speed. In particular, in high-speed galvanized steel wire production lines, the wires must be cooled in the order of 250-300° C. so as to reach the 460 to 500° C. of the zinc bath.

Cooling the wire in the annealing step using tubes with a water sleeve, which assures that the wail is cold at all times, is known. Due to their high temperature, the wires are cooled by radiation. Unfortunately, this known system is insufficient and presents some drawbacks. First, the cooling rate is low, which limits the wire speed. Furthermore, the length to be cooled significantly lengthens the line in the order of tens of meters. On the other hand, due to its length, threading of the wire may be very difficult. Finally, in this known solution, dirt readily builds up in the tubes. Another relevant problem is the risk of the wire oxidizing.

Document US 2007107815 A1 discloses a method for patenting a steel wire, according to which the temperature is increased at east to a level at which the steel austenitizes. The wire is then quenched in a liquid medium by passing the wire through at least one curtain of cooling liquid so as to obtain a coding temperature below the austenitizing temperature. The liquid flows in a turbulent manner in a direction substantially perpendicular to the wire. Next, the method has an isothermal stage during which the wire is maintained at a constant temperature allowing pearlite transformation. Several successive curtains of cooling liquid which hit the wire on the lower portion thereof are furthermore provided in the method to obtain the temperature that allows pearlite transformation.

Document FR2300810A1 discloses a method for patenting steel wire. The wire is heated to form austenite and isothermally quenched to obtain pearlite. In the addition, the isothermal quenching occurs in three successive phases: (a) the outer layer of the wire is cooled below the temperature of the nose of the time-temperature-transformation curve (TTT); (b) the outer layer is reheated by the heat contained in the core of the wire; to a uniform temp. near to that of the nose of the TTT curve, before transformation is complete; and c) the uniform temperature is maintained at least until the complete transfer of austenite into ferrite and cementite.

Document CN 101736143 A discloses a wire annealing process and a device therefor. The wire annealing process mainly comprises three working procedures of heating treatment in a high temperature annealing region, cooling treatment in a steam cooling region and liquid water coating and cooling treatment in a liquid water coating and cooling region. Steam in the steam cooling region is low-temperature steam generated by a built-in steam generator, thereby realizing high cooling efficiency, having no problem of condensate and being applied in annealing of a variety of wires; furthermore, due to the working procedure of the liquid water coating and cooling treatment, the wire annealing process cannot easily complete the wire cooling, but also better complete the tasks of coating of an antioxidant, coating a booster flux, cleaning the booster flux and the like. Therefore, the wire annealing process and the device thereof can avoid the oxidation of annealed wires, improve the performance and the quality stability of the wires after annealing, further realize the perfect coating of the antioxidant and the pretreatment of tin plating, have good energy-saving effect and be applied in the annealing of a variety of wires.

Finally, document EP 0359279 A2 discloses a method for rapid direct cooling of a hot-rolled wire rod.

### SUMMARY OF THE INVENTION

The purpose of the invention is to provide a cooling device for cooling a wire of the type indicated above which, by cooling at a high speed of travel, prevents the wire from oxidizing and therefore provides a high quality wire.

In the art, the values used for characterizing a high-speed wire processing line are the values DV and D2V. DV is the product of the diameter D of the wire measured in mm by the speed of forward movement of the wire V measured in m/min. In turn, D2V is the product of the square of the diameter of the wire measured in mm by the speed of forward movement of the wire V measured in m/min.

Therefore, in the invention a high-speed line is considered a line having a DV≥150 mm mania and D2V≥500 mm²·m/min.

On the other hand, in the invention, mean speed at the cooling liquid inlet, i.e., the speed at the point of ejection of the jet of cooling liquid, is understood as the volumetric flow rate expressed in m³/s, under pressure and temperature conditions of 0° C. and 1 atm, divided by the area of the cross-section of the cooling liquid inlet expressed in m².

Therefore, the purpose of the invention is achieved by means of a cooling device for cooling a wire of the type indicated above, characterized in that it further comprises a second cooling chamber comprising a wire inlet and a wire outlet arranged with respect to one another such that they define a wire path and at least one cooling liquid inlet and one cooling liquid outlet, and cooling liquid driving means fluidically connecting said first and second chambers for driving said cooling liquid from said first chamber to said second chamber through said at least one cooling liquid inlet, said driving means and the cross-section of said at least one cooling liquid net being dimensioned to project a jet of cooling liquid on said wire path at a mean speed of at least 0.6 m/s, said jet of liquid being projected from a distance between said cooling liquid inlet and said path comprised between 6 and 13 times the diameter of the wire that must be cooled, said cooling liquid outlet furthermore extending into said first chamber, such that when said cooling device is in operation, the distal end of said cooling liquid outlet is submerged in the cooling liquid held in said first chamber, and in that it further comprises means for introducing inert gas, functionally associated with said second chamber to create an inert gas atmosphere inside said second chamber during the cooling of said wire.

The wire cooling device is based on convection cooling which is much more efficient than radiation cooling known in some installations of the state of the art. This allows cooling the wire preventing oxidation in addition to being much faster. Accordingly, compared with the radiation cooling devices of the state of the art the length of the station for one and the same cooling gradient can be reduced, gaining processing speed.

The driving means and the cross-section of the cooling liquid inlet are dimensioned such that they allow projecting a jet of cooling liquid on the wire at a high speed and in a very precise manner. This would not take place with the water curtains disclosed in the state of the art. Furthermore, the formation of a vapor layer in the interface between the cooling liquid and the wire is thereby prevented. During the development of the invention, it has been found that the vapor layer favors wire oxidation. On the other hand, it also hinders wire cooling. Likewise, by introducing an inert gas in the second chamber undesired chemical reactions that may degrade the wire are also prevented from taking place. In particular, in the known systems of the state of the art the oxygen existing in the cooling chamber is one of the decisive elements in wire surface oxidation, because surface oxidation occurs when the oxygen contacts the wire. This directly affects the quality of the wire that is produced as the subsequent processing thereof, such as coating by means of galvanization, for example, is also hindered.

An example of the drawbacks of the devices of the state of the art can be seen in the device disclosed in document US 2007107815 A1. In said document, the water curtains contain bubbles which make uniform cooling difficult and again favor the formation of vapor layers on the wire. On one hand, this negatively affects the quality of the wire, causing the oxidation thereof. Furthermore, this also makes it necessary to work at a low speed to assure that the entire wire surface is in contact with water at some point for uniform cooling. This installation is also very inefficient given that a large part of the jet in the form of a water curtain is not used for cooling. In fact, a large part of the turbulent water curtain is driven for no specific purposes, which entails unnecessary power consumption.

The invention covers a series of preferred features which are the object of the dependent claims, the usefulness of which is set forth below in the detailed description of an embodiment of the invention.

Preferably said inert gas comprises at least nitrogen and hydrogen, said hydrogen having a concentration by weight between 0 and 10% w/w, preferably between 0 and 7.5% w/w, and particularly preferably between 0 and 5% w/w. Accordingly, the nitrogen comprises a concentration between 100 and 90% w/w, preferably between 100 and 92.5% w/w, and particularly preferably between 100 and 95% w/w. Hydrogen in a suitable proportion is particularly desirable given that the oxygen coming from water is captured to form water again. Therefore, the risk of wire surface oxidizing during the cooling step is further reduced.

Preferably said coding liquid inlets are configured for projecting a localized jet on said path, said cooling liquid inlets being arranged around the perimeter of said path, along a 270° symmetrical angle with respect to a vertical plane. Since the cooling liquid is not projected from the lower part, the hot liquid that has already come into contact with the wire is prevented from falling onto said wire again, and therefore cooling in a much less efficient manner.

In another embodiment, the cooling liquid inlets are arranged around the perimeter of said path in a uniform manner, around an angle comprised between 0 and 180°, which also reduces the power consumption of the device, given that water jets are not projected against the direction of gravity.

Even more preferably, said second chamber comprises a plurality of cooling liquid inlets uniformly distributed in the longitudinal direction of said path and in the upper part of said second chamber. This allows cooling the wire even more quickly, given that there is a larger amount of cooling liquid projected on the wire. In a particularly preferred manner, between 15 and 50 liquid inlets are provided uniformly distributed in the longitudinal direction. Therefore, for example, when 5 liquid inlets are provided on a transverse plane distributed around the perimeter, between 45 and 250 cooling liquid inlets could be provided in the entire device.

In a particularly preferred manner, said cooling liquid inlets are of a circular cross-section. This simplifies its manufacturing. In a particularly preferred manner, the holes configuring the cooling liquid inlets are of a circular cross-section with a diameter comprised between 1 and 4 mm, depending on the diameter of the wire to be cooled.

Furthermore, in order to provide greater flexibility in terms of the form of the jet, said cooling liquid inlets have a cross-section that can be modified or adjusted, i.e., the dimensions of the cross-section can be varied depending on the geometric needs of the wire to be cooled.

Preferably, said driving means and the cross-section of said at least one coding liquid inlet, are dimensioned to project said jet of cooling liquid on said wire path at a mean speed of at least 3 m/s, and preferably at least 5 m/s. A higher projection speed minimizes the risk of formation of the vapor layer, particularly when the jet has a width smaller than the cross-section of the wire.

In a particularly preferred manner, the flow rate used to discharge the jets of liquid is comprised between 6 l/min and 60 l/min.

In another embodiment having the object of optimizing cooling liquid consumption, preferably, the width of the cross-section of said at least one cooling liquid inlet on the plane perpendicular to said wire path is between 30% and 120% of the maximum diameter of said wire.

Preferably said cooling liquid is one from the group consisting of mains water, demineralized water, or a solution of salts and/or polymers in water. As a result, the device design is simplified and safety is increased. Water is a cooling liquid that is readily available In industries and is safe to handle. On the other hand, this prevents the need to store other specific liquids. Alternatively, glycol or cutting oil, known in the art as lubricant, can be used.

Another object of the invention is to provide a continuous wire processing installation comprising a cooling device for cooling the wire as described above.

In order to reduce the risk of formation of an oxide layer on the wire surface to a minimum, the installation comprises upstream of the cooling step a thermal treatment station, said installation comprising a thermal treatment chamber having heating means for heating said wire at a first temperature and means for introducing inert gas to create an inert gas atmosphere in said chamber. As a result of the inert gas, despite the temperature of the wire being increased to perform thermal treatment, the formation of oxide is prevented.

In another embodiment, the installation comprises a galvanizing station arranged downstream of said cooling station, said galvanizing station comprising a galvanizing chamber and means for introducing inert gas to create an inert gas atmosphere in said galvanizing chamber, said galvanizing station being fluidically connected with said cooling station.

Finally, in a particularly preferred manner said thermal treatment station, said galvanizing station, and said cooling station are fluidically connected with one another such that they share said inert gas atmosphere. This prevents any risk of formation of an oxide layer in all these steps.

Another object of the invention consists of a cooling method for cooling a wire which allows cooling the wire at a high speed, without negatively affecting the quality of the produced wire. This purpose is achieved by means of a cooling method for cooling a wire of the type indicated above, characterized in that it comprises a cooling liquid projection step, in which at least one jet of cooling liquid is projected on said wire path at a mean speed of at least 0.6 m/s from a distance between the cooling liquid inlet and said path comprised between 6 and 13 times the diameter of the wire that must be cooled, and in that said projection step is performed in an inert gas atmosphere.

Preferably, said inert gas comprises at least nitrogen and hydrogen in a concentration by weight between 0 and 10% w/w, preferably between 0 and 7.5% w/w, and particularly preferably between 0 and 5% w/w. As a result of the hydrogen, the oxygen coming from water is captured to form water again. Therefore, the risk of the wire surface oxidizing during the cooling step is further reduced.

Preferably, said mean speed for projecting cooling liquid on said wire is at least 3 m/s, and preferably at least 5 m/s. A higher projection speed minimizes the risk of formation of the vapor layer. On the other hand, higher speeds are suitable also for larger wire sections.

Preferably, said at least one jet of cooling liquid is a localized jet, said jet being projected around the perimeter of said path, along a 270° symmetrical angle with respect to a vertical plane. This prevents the hot, projected cooling liquid from failing onto the wire again. Water that has already come into contact with the wire previously, and therefore has already started to heat up, falling onto said wire would cause the wire to cool in a rather inefficient manner.

In another embodiment, the at least one jet of coding liquid is projected around the perimeter of said path in a uniform manner, around an angle comprised between 0 and 180° with respect to the horizontal direction for optimizing the power consumption of the installation.

Likewise, the invention also includes other features of detail illustrated in the detailed description of an embodiment of the invention and in the accompanying figures.

### BRIEF DESCRIPTION OF THE DRAWINGS

Further advantages and features of the invention will become apparent from the following description, in which, without any limiting character, preferred embodiments of the invention are disclosed, with reference to the accompanying drawings in which:

FIG. 1 shows a schematic front view of a first embodiment of an installation according to the invention.

FIG. 2 shows a perspective view of a cooling device for cooling a wire according to the invention.

FIG. 3 shows a top plan view of the device of FIG. 2.

FIG. 4 shows a general scheme of the wire cooling device according to the invention.

FIG. 5 shows a longitudinally sectioned view of the second cooling chamber in which the wire is cooled.

FIG. 6 shows a schematic cross-section along plane VI-VI of the second chamber of FIG. 5.

FIGS. 7a and 7b show diagrams from the analysis of the speed of the jets projected on the wire in a second cooling chamber of the device according to the invention.

FIG. 8 shows a schematic front view of a second embodiment of an installation according to the invention.

### DETAILED DESCRIPTION OF AN EMBODIMENT OF THE INVENTION

In order to better understand the operation of the device 1 for coding wire 100 according to the invention, a wire processing method according to the invention is first described by way of non-limiting example. More particularly, a method for coating a steel wire by galvanization is described in this case. Nevertheless, the method according to the invention is applicable to other continuous wire processing methods for processing wires made of other materials. In particular, the method is applicable to wire processing methods in which a cooling step is required after raising the temperature of the wire which causes a crystallographic change and accordingly leads to a risk of oxidizing the surface thereof. By way of example, and depending on the carbon content, in the case of a steel wire, the temperature is raised above 400° C.

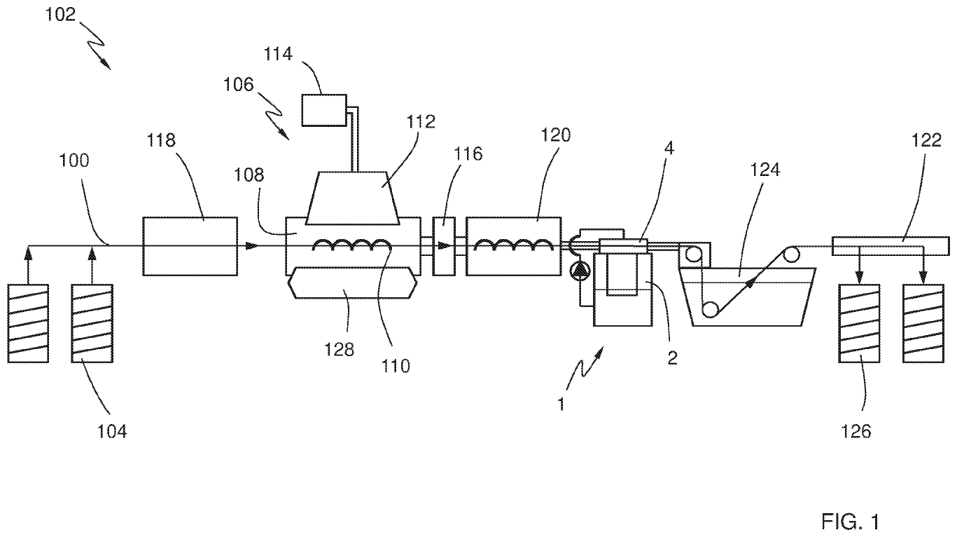

FIG. 1 shows an installation 102 for coating a wire 100 by galvanization. First, the installation 102 has a wire pay-off station with two pay-off devices 104 of wire 100 by way of a reel rotatably mounted on its corresponding support not shown in detail. If needed, the wire 100 leaving the reels can be slowed down to assure the correct tension of the wire 100 in subsequent processes.

FIG. 1 depicts two pay-off devices 104, i.e., a machine suitable for treating two wires simultaneously is depicted. Nevertheless, within the scope of the invention the number of treated wires 100 is irrelevant. Despite the foregoing, for the sake of simplicity, the different embodiments below will be described in reference to a single wire 100, which must not interpreted in a limiting manner. Accordingly, unless otherwise indicated the description will be applicable to one, two, or more wires 100.

The installation 102 has a cleaning station 106 with a first induction oven 108 for cleaning the surface of the wire 100 before the application of the thermal treatment prior to coating. Nevertheless, alternatively, the oven can be a conventional oven. This first oven 108 can be both a voltage source and a current source. The first oven 108 provides the power required to raise the temperature of the wire 100 to a temperature comprised between 400 and 600° C. To that end, the first oven 108 has an inductor with the corresponding wire 100 going through the inside thereof. Both in the case of single-wire and multi-wire machines, each of the inductors is configured by way of an open reel without any ceramic tube in the center of the inductors. Accordingly, waste eliminated by gravity from the surface of the wire 100 can be discharged through the lower part thereof. Alternatively, the inductor 110 can also be half-open, such that the upper part of the inductor 110 is protected with a ceramic bushing, whereas the lower part is open.

A smoke extractor 112 which directs fumes to a fume filter 114 is also provided in the first oven 108. On the lower part of the inductor, the cleaning station 106 has an ash collection device 128, by way of a removable tray, provided below the inductor, occupying the entire length and width thereof, such that the ash coming off the wire 100 always falls onto the tray to be properly discharged.

After the pay-off device 104 and upstream of the first induction oven 108, the cleaning station 106 comprises an impregnation device 113 containing a highly volatile liquid, such as water, alcohol, acid, solvent, or the like. The wire 100 is impregnated by spraying, dipping, rubbing, or the like in the impregnation device 118 before entering the first induction oven 108.

Finally, a cleaning device 116 for cleaning burned remains from the surface of the wire 100 is also provided in the cleaning station 106 downstream of the first oven 108. This cleaning device 116 is optional according to the level of cleanliness to be obtained. Most of the waste present on the surface of the wire 100 is eliminated in the first oven 108. Nevertheless, this system is responsible for eliminating possible waste which, after being burned in the first oven 108, adhere to the surface of the wire 100 and did not fall by gravity. The cleaning device 116 for cleaning burned remains can be, among others: pressurized water, nitrogen, pressurized air, recirculating water, or other fluids, and similar systems. Alternatively, mechanical cleaning, i.e., cleaning device 116 comprising mechanical means such as rotating brushes, rotating cylinders covered with cloth, pads, or the like intended for scrubbing the surface of each of the wires 100 to eliminate the remaining solid waste, is not rued out either.

The installation 102 comprises a thermal treatment station after the cleaning device 116, downstream of the first induction oven 108. The thermal treatment station has a second oven 120 with a thermal treatment chamber having heating means for heating the wire 100 at a first temperature. In a particularly preferred manner, the station also has means for introducing inert gas, not shown in detail, to create an inert gas atmosphere in the thermal treatment chamber. As mentioned, the thermal treatment of the wire 100 consists of raising the temperature thereof until causing a crystallographic modification of the steel. To that end, this second oven 120 must be suitable for heating the wire 100 at a thermal treatment temperature. Within the scope of the invention, the thermal treatment can be any of the conventional treatments applied to a steel wire before the subsequent processing thereof, either with or without subsequent coating. For example, the thermal treatment applied in the second oven 120 can be an annealing, patenting, or tempering treatment prior to galvanization or an austenitizing treatment which is applied in the case of a stainless steel wire which does not required subsequent coating.

As already seen the thermal treatment is preferably carried out in an inert gas atmosphere, such as a combination of hydrogen and nitrogen, for example, to prevent oxidation. Nevertheless, within the context of the invention, it is not essential for the thermal treatment to be performed in an inert atmosphere.

The installation 102 has a cooling station with at least one cooling device for cooling a wire 100 at the outlet of the second thermal treatment oven 120. The device 1 will be described in further detail below.

Next, the installation has a galvanizing station downstream of the cooling station. This station has a galvanizing chamber 124 with a zinc bath and means for introducing inert gas (not shown in detail) to create an inert gas atmosphere in the galvanizing chamber 124. Alternatively, different coatings such as phosphate coatings, rilsan coatings, copper coatings, lacquer coatings, plastic coatings, or the like, other than galvanized coating, can be applied in the bath. Again, the inert atmosphere of the galvanizing station is optional, but it greatly improves the finish quality of the coating.

Likewise, in the preferred embodiment of FIG. 1 the thermal treatment station, the galvanizing station, and the cooling station are fluidically connected with one another such that they share the inert gas atmosphere.

A solidifying device 122 for solidifying the galvanizing layer which is responsible for assuring good uniformity of the coating is provided after the galvanizing station. In this case, the coating solidifying device 122 also cools the wire 100. Nevertheless, in this case there is no risk of oxidation in the thermal treatment station, given that the wire 100 is coated with zinc.

Finally, a collection device 126 for collecting the wire 100 consisting of a motor-operated winding reel for each of the wires 100 is provided at the outlet of the solidifying device 122.

The cooling device 1 object of the invention is described next. This device 1 can be provided in the cooling station of a continuous wire galvanizing installation 102.

As can be seen in the drawings, and particularly in FIG. 4, the cooling device 1 for cooling a wire 100 according to the invention has a first containing chamber 2 for containing the cooling liquid. A particularly preferred liquid for cooling the wire 100 is mains water, given that it is readily available industrial installations. Nevertheless, other liquids such as demineralized water, glycol, a solution of salts and/or polymers in water, lubricants, or others, may be used.

Furthermore, the second chamber 4 comprises a wire inlet 6 for the entry of the wire 100 to be cooled and a wire outlet 8 for the ext of the wire 100 once it has been cooled. These wire inlet and outlet 6, 8 define a wire path 10. The path 10 is preferably, but not essentially, rectilinear in order to minimize space. The path 10 for the wire substantially coincides with the longitudinal axis of the wire 100 going through the inside of the second chamber 4 in order to be cooled. On the other hand, this same second chamber 4 has a plurality of cooling liquid inlets 12 and at least one cooling liquid outlet 14, arranged on the lower portion thereof by way of a longitudinal box.

The device 1 has also cooling liquid driving means 16, such as a hydraulic pump, fluidically connecting the first and second chambers 2, 4. The driving means 16 are provided for driving the cooling liquid from the cooling liquid bath in the first chamber 2 to the second chamber 4 through the plurality of cooling liquid nets 12 provided in an accumulation chamber 24 surrounding the second chamber 4.

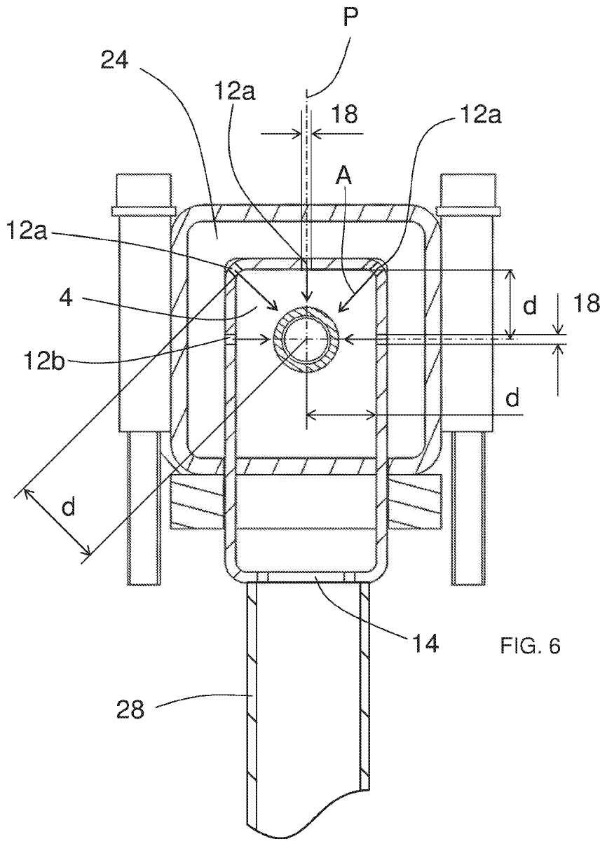

As seen in FIG. 6, the driving means 16 and the cross-section of the cooling liquid inlets 12 are dimensioned to project a jet of cooling liquid on the wire path 10 at a mean speed of at least 0.6 m/s. The jet of liquid is projected from a distance d between said cooling liquid inlet 12 and said path comprised between 6 and 13 times the diameter of the wire 100 that is to be cooled. With this speed, the wire is prevented from oxidizing because the formation of a vapor layer around the wire is largely prevented. The vapor layer favors the oxidation of the wire, but also further complicates the cooling thereof. Nevertheless, even more preferably a further enhanced cooling effect is achieved from a speed of at least 3 m/s, and more preferably at least 5 m/s.

In a particularly preferred manner, the cooling liquid inlets 12 are holes of a circular cross-section with a diameter comprised between 1 and 4 mm. Furthermore, the flow rate is comprised between 6 l/min and 60 l/min.

Likewise, for optimizing the cooling capacity and power consumption of the installation, it is provided that, in the device 1, the width 18 of the cross-section of each of the cooling liquid inlets 12 on the plane perpendicular to the wire path 10 is between 30% and 120% of the maximum diameter of the wire that must be cooled. In the invention, the width 18 of the cross-section of the cooling liquid inlets 12 is understood as the dimension of the liquid inlet measured on the plane perpendicular to the wire path 10, as seen in FIG. 6.

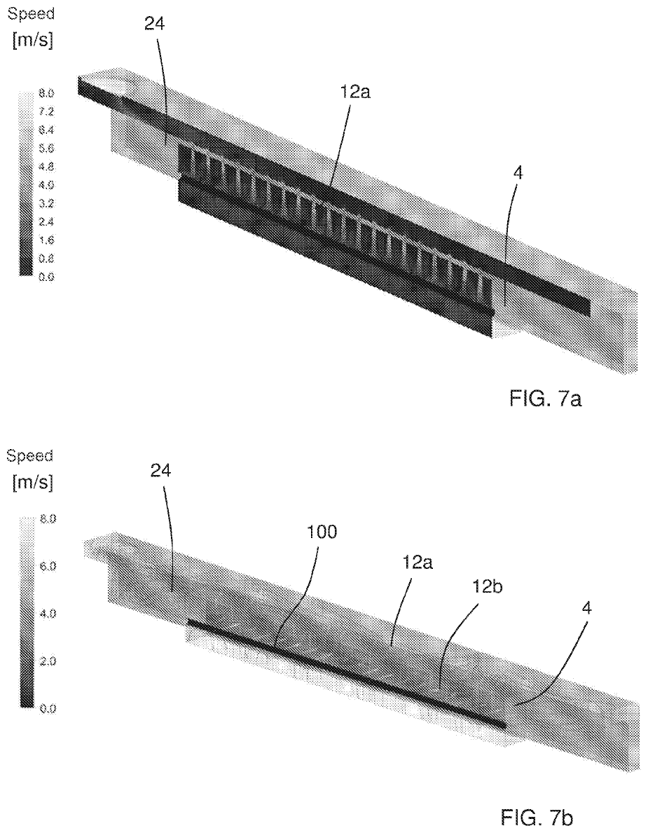

Likewise, FIGS. 6 and 7 show that the cooling liquid inlets 12 are configured for projecting a localized jet on the path 10, indicated in FIG. 6 with arrow A. It can be seen in this same drawing that the cooling liquid inlets 12 are arranged around the perimeter of said path 10, along a symmetrical angle of 180° with respect to a vertical plane P. The perimetral distribution may extend symmetrically to 270° with respect to plane P to prevent the heated cooling liquid that has already come into contact with the wire 100 from falling onto the wire again, impairing the cooling of the wire. In fact, the perimetral distribution considered the most efficient in terms of cooling and power consumption of the installation is achieved when the cooling liquid inlets 12a, 12b are arranged around the perimeter of the path in a uniform manner around an angle comprised between 0 and 180°, like in the case of the drawing.

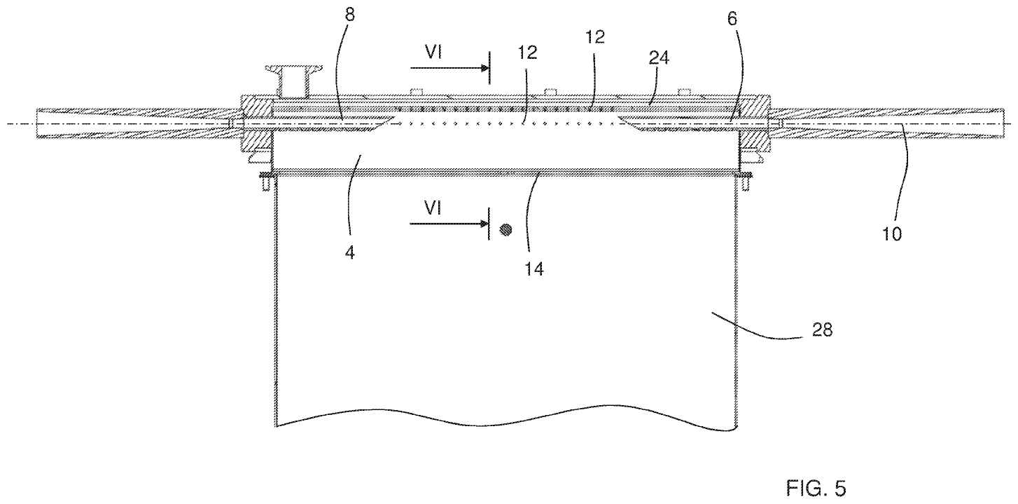

On the other hand and to enable assuring a good, high-speed cooling, it can be seen in FIG. 5 that the second chamber 4 comprises a plurality of cooling liquid inlets 12 in the second chamber 4 which are uniformly distributed in the longitudinal direction of the path 10 and in the upper part 22 of said second chamber 4.

It can also be seen in FIG. 4 that the cooling liquid outlet 14 extends in the form of a vertical tubular conduit 28 of a rectangular cross-section into said first chamber 2. Therefore, when the device 1 is in operation, the distal end 20 of the cooling liquid outlet 14 is submerged in the cooling liquid bath held in the first chamber 2.

The device 1 further comprises means for introducing inert gas. These means for introducing inert gas are functionally associated with the second chamber 4 to create an inert gas atmosphere inside the second chamber 4 during coding of the wire 100. In particular, the fact that the distal end 20 is submerged in the liquid bath of the first chamber 2 assures than the entire second chamber 4 is arranged in an inert gas atmosphere. This inert atmosphere is schematically shown in FIG. 4 by means of a gray-colored background.

As mentioned, the second chamber 4 contains the inert gas 130 which prevents any unwanted chemical reaction, and particularly the oxidation of the surface of the wire 100, from occurring. The preferred inert gas 130 comprises at east nitrogen and hydrogen in a concentration by weight between 0 and 10% w/w. Nevertheless, for increased operation safety, the concentration of hydrogen is preferably between 0 and 7.5% w/w, and particularly preferably between 0 and 5% w/w.

FIGS. 7a and 7b shown an example of the form of jet achieved through the cooling liquid inlets of the device of the invention. FIG. 7a shows only a simulation of half of the second chamber 4. Five inlets are arranged on each transverse plane on which cooling liquid inlets 12 are provided. Three upper inlets 12a are distributed in the first and second quadrants, whereas the two lower inlets 12b which are not seen in this drawing. This diagram shows the jet as a localized jet. Obviously, the jet loses speed as it comes out of the corresponding inlet. In any case, the mean jet speed in this case is at least 3 m/s.

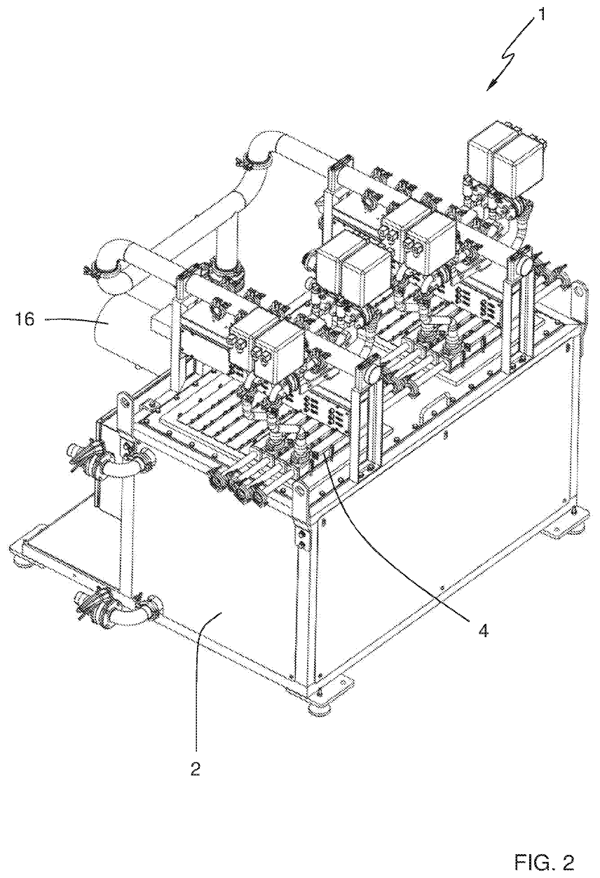

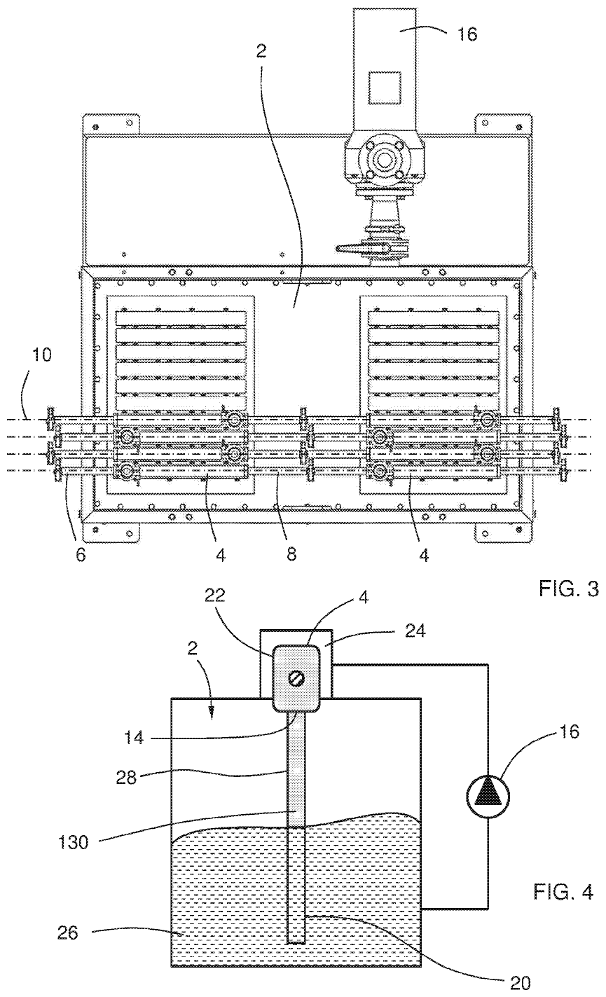

The method according to the invention is described below based on the device of FIGS. 2 to 6. The cooling method for cooling a wire comprises a cooling liquid projection step in which five jets of water are projected on the wire at a mean speed of at least 0.6 m/s, but preferably at least 3 m/s, and more preferably 5 m/s. The projection step is performed in an inert gas atmosphere 130.

In particular, the inert gas atmosphere 130 is achieved as a result of the introduction of nitrogen and hydrogen in the second chamber 4. The mixture contains hydrogen in a concentration by weight between 0 and 10% w/w, preferably between 0 and 7.5% w/w, and particularly preferably between 0 and 5% w/w.

FIG. 7a shows how the cooling liquid is projected in the form of a localized jet through the upper cooling liquid inlets 12a.

FIG. 7b shows a simulation similar to that of FIG. 7a, but in which the 45° cooling liquid inlet 12a and a horizontal cooling liquid inlet 12b are shown.

The combination of FIGS. 7a and 7b allows observing how the cooling liquid is distributed around the perimeter of the wire path, except the lower vertical position.

These drawings show how the jet of cooling liquid is highly localized and very precisely applied. As a result of the high speeds with which each of the jets is projected, the formation of a vapor layer on the surface of the wire is prevented. This technical effect, in combination with the inert atmosphere existing inside the second chamber 4, prevents the risk of oxidation.

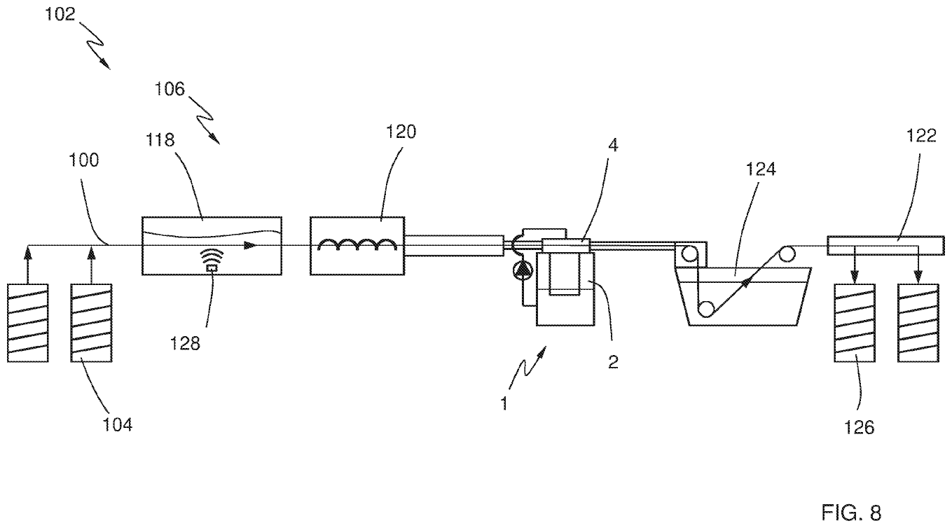

An alternative form of the installation 102 of the invention which shares many features in common with the installation of FIG. 1 is described based on FIG. 8. Accordingly, reference is made to the description of the preceding paragraphs with respect to the common features, whereas only the different features will be described below.

The installation of FIG. 8 differs significantly in the cleaning station 106. In this case, cleaning through the first induction oven 108 is dispensed with and replaced with the impregnation device 118 containing a highly volatile liquid, such as water, alcohol, acid, solvent, phosphoric acid, or the like. The wire 100 is impregnated in the impregnation device 118. Simultaneously, ultrasound generating means 128 which, in combination with the liquid, are capable of causing the detachment of the solid remains adhered to the surface of the wire 100, as well as stearates resulting from the prior wire drawing process, are provided in the impregnation device 118.

The device 1 and the method, as well as the installation 102 in which the method can be put into practice, allow cooling the wire at a very high processing speed without compromising to that end the quality of the obtained product, i.e., preventing the formation of an oxide layer affecting the rough wire, or subsequent coating steps.

1. A cooling method for cooling a wire running along a wire path in a cooling device for cooling a wire, comprising:
a first containing chamber for containing a cooling liquid, further comprising:
a second cooling chamber comprising a wire inlet and a wire outlet arranged with respect to one another such that they define a wire path and at least one cooling liquid inlet and one cooling liquid outlet,
cooling liquid driving means fluidically connecting said first and second chambers for driving said cooling liquid from said first chamber to said second chamber through said at least one cooling liquid inlet,
said cooling liquid outlet furthermore extending into said first chamber, such that when said cooling device is in operation, the distal end of said cooling liquid outlet is submerged in the cooling liquid held in said first chamber,
said driving means and the cross-section of said at least one cooling liquid inlet being dimensioned to project a jet of cooling liquid on said wire path, wherein
the device further comprises means for introducing inert gas, functionally associated with said second chamber to create an inert gas atmosphere inside said second chamber during the cooling of said wire, and
the method further comprises:
a cooling liquid projection step, in which at least one jet of cooling liquid is projected on said wire path at a mean speed of at least 0.6 m/s from a distance between the cooling liquid inlet and said path comprised between 6 and 13 times the diameter of the wire that must be cooled, and
said projection step being performed in an inert gas atmosphere.

2. The cooling method for cooling a wire according to claim 1, wherein said inert gas comprises at least nitrogen and hydrogen in a concentration by weight between 0 and 10% w/w.

3. The cooling method for cooling a wire according to claim 1, wherein said mean speed for projecting cooling liquid on said wire is at least 3 m/s.

4. The cooling method for cooling a wire according to claim 1, wherein said at least one jet of cooling liquid is a localized jet, said jet being projected around the perimeter of said path, along a 270° symmetrical angle with respect to a vertical plane.

5. The cooling method for cooling a wire according to claim 4, wherein the at least one jet of cooling liquid is projected around the perimeter of said path in a uniform manner, around an angle comprised between 0 and 180° with respect to the horizontal direction.

6. The cooling method for cooling a wire according to claim 1, wherein said cooling liquid is one from the group consisting of mains water, demineralized water, a solution of salts and/or polymers in water, glycol, or cutting oil.

7. The cooling method for cooling a wire according to claim 4, wherein said second chamber comprises a plurality of cooling liquid inlets uniformly distributed in the longitudinal direction of said path and in the upper part of said second chamber.

8. The cooling method for cooling a wire according to claim 1, wherein the width of the cross-section of said at least one cooling liquid inlet on the plane perpendicular to said wire path is between 30% and 120% of the maximum diameter of the wire that must be cooled.

9. The cooling method for cooling a wire according to claim 2, wherein said inert gas comprises at least nitrogen and hydrogen in a concentration by weight between 0 and 7.5% w/w.

10. The cooling method for cooling a wire according to claim 2, wherein said inert gas comprises at least nitrogen and hydrogen in a concentration by weight between 0 and 5% w/w.

11. The cooling method for cooling a wire according to claim 3, wherein said mean speed for projecting cooling liquid on said wire is at least 5 m/s.
